(19) United States
(12) Patent Application Publication
(10) Pub. No.: US 2017/0320510 A1
(43) Pub. Date: Nov. 9, 2017

(54) Foldable Multiple Level Cart

(71) Applicant: Robert JAMES, Gabriola Island (CA)

(72) Inventor: Robert JAMES, Gabriola Island. (CA)

(21) Appl. No.: 14/909,129

(22) PCT Filed: Aug. 30, 2014
(86) PCT No.: PCT/IB2014/064160

§ 371 Date: Jan. 31, 2016

Related U.S. Application Data
(60) Provisional application No. 61/872,666, filed on Aug. 31, 2013.

(51) Int. Cl. B62B 3/02; B62B 5/00

(52) U.S. Cl. CPC B62B 3/027; B62B 3/025; B62B 5/0026

(57) ABSTRACT

A foldable cart having a first lower cargo compartment and a second upper cargo compartment vertically aligned over the lower cargo compartment, a front wall, a rear wall, a left wall, a right wall, a lower compartment floor, and an upper compartment floor, the upper compartment floor forming a ceiling for the lower compartment; at least one pair of rear-mounted wheels and one pair of front-mounted wheels, at least one of the pairs of wheels mounted on an axle; swivel connectors for attaching each of the front wheels to the lower compartment floor; a handle; and a locking mechanism for securely closing one or more of the compartments.

### FIELD OF THE INVENTION

The present invention relates to cargo carriers. In particular, the present invention relates to collapsible carts.

### BACKGROUND OF THE INVENTION

Increasingly, consumers are adapting their shopping to accommodate a decreased use of automobiles, and increased bicycle and pedestrian means for getting to and from shops. It is desirable, therefore, to provide a foldable multiple level cart for use travelling to and from shopping locations, as well as for use during shopping.

It is known to provide a grocery shopping cart. Such carts generally are large and bulky, and occupy too much storage space to be conveniently used by consumers storing their cart at home. It is also know to provide a rolling cart which may be folded in some manner to reduce their storage size. Such carts do not, however, provide multiple level compartments, and they do not offer optional security measures which consumers may want.

It is desirable, therefore, to provide a strong, foldable, multiple level cart which offers means for secure storage of cargo and may be folded into a compact package for storage.

### SUMMARY OF THE INVENTION

There is provided a foldable cart comprising cargo storage means comprising a first lower cargo compartment and a second upper cargo compartment vertically aligned over the lower cargo compartment, the cargo storage means having a front wall, a rear wall, a left wall, a right wall, a lower compartment floor, and an upper compartment floor; rolling means; steering means; and an adjustable height handle.

The rolling means may be at least one pair of rear-mounted wheels and one pair of front-mounted wheels, at least one of the pairs of wheels may be mounted on an axle.

The steering means may comprise swivel connectors for attaching each of the front wheels to the lower compartment floor.

The height of the front wall may be less than the height of each of the left, right, and rear walls, and the upper compartment floor may form a ceiling for the lower compartment.

There may be provide an electric motor and a pair of drive wheels, as well as a radio frequency identification tag for tracking of the cart and a locking mechanism for securely closing one or more of the compartments.

Cover means adapted to fit the size and shape of the cart in its open position may be provided. The cover means may be an opaque, waterproof, heavy duty fabric. There may also be provide a security liner inserted along the inside surfaces of one or more of the compartments.

Each of the right and left walls may have a first fixed vertical segment adjacent the rear wall, and a second rotatable vertical segment adjacent the front wall, the second vertical segments rotatable relative to the first vertical segments along their vertical length. Each of the upper and lower floors may be rotatable about its rearward edge where it connects with the rear wall and about its frontward edge where it connects with the front wall. The upper and lower floors may be rotated upwardly into a position parallel to the rear wall, and the second vertical segments of the left and right walls may then be rotated inwardly to overlap in front of the front wall to fold the cart into a compact size for transportation or storage.

### BRIEF DESCRIPTION OF THE DRAWINGS

A detailed description of the preferred embodiments is provided below by way of example only and with reference to the following drawings, in which:

FIG. 1 is a front perspective view of one embodiment of the invention in an open position;

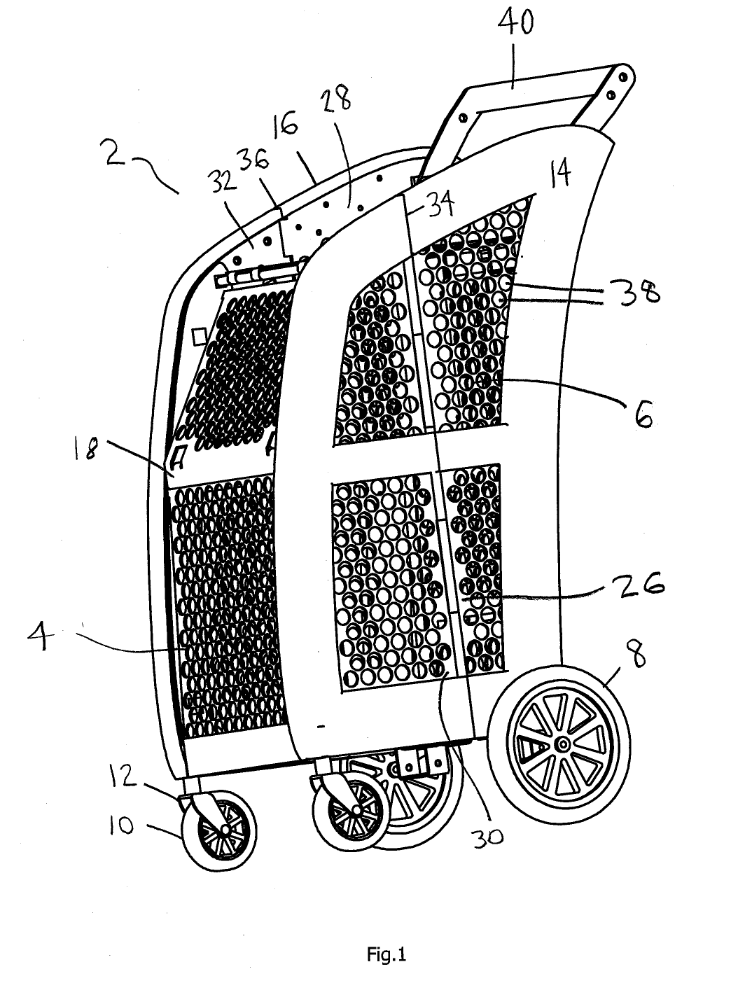

FIG. 2 is a front perspective view of one embodiment of the invention in a transitional position;

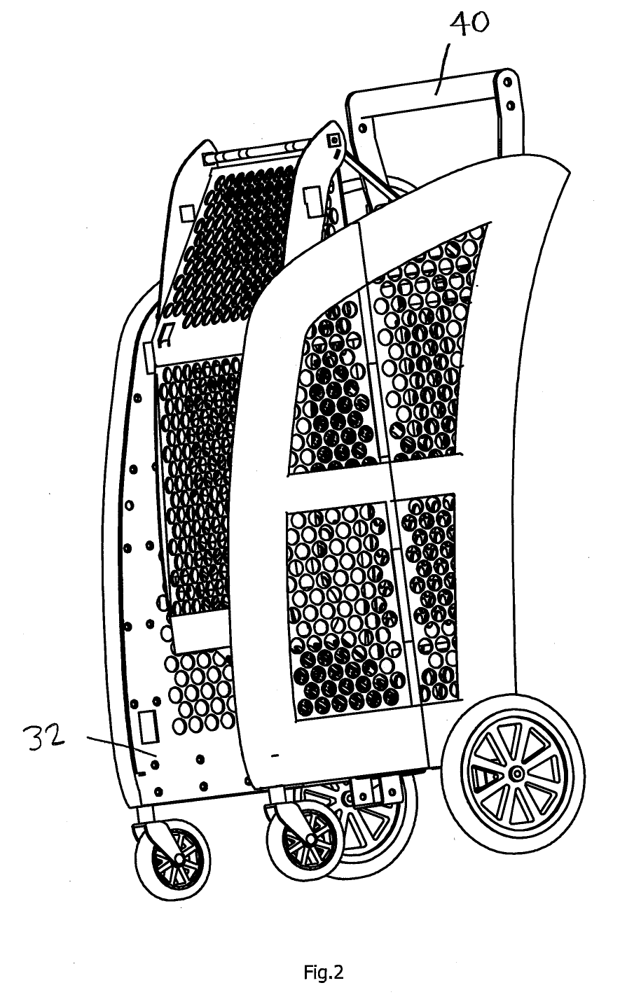

FIG. 3 is a front perspective view of one embodiment of the invention in a closed position;

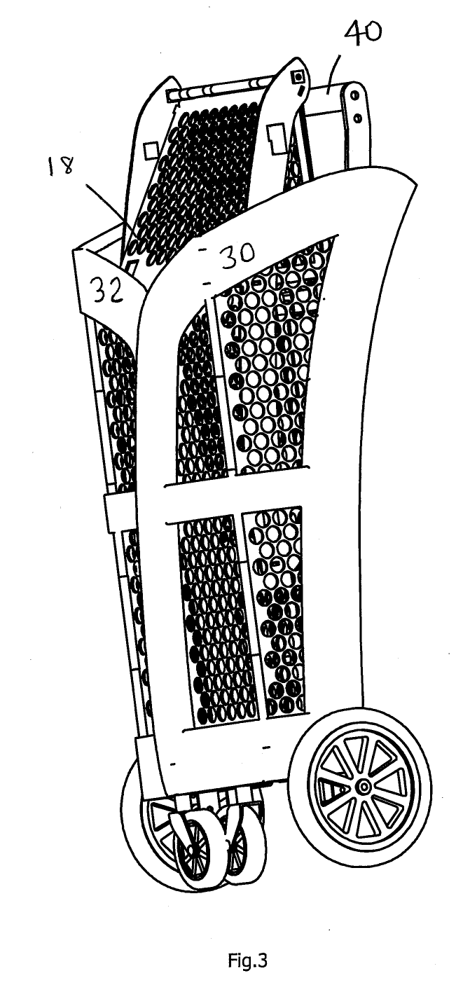

FIG. 4 is a side plan view of one embodiment of the invention in an open position;

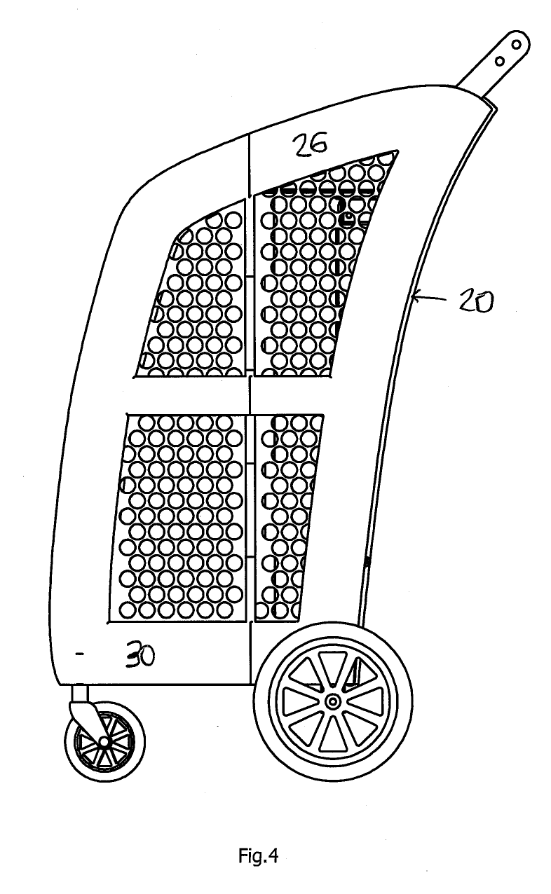

FIG. 5 is a side plan view of one embodiment of the invention in a closed position;

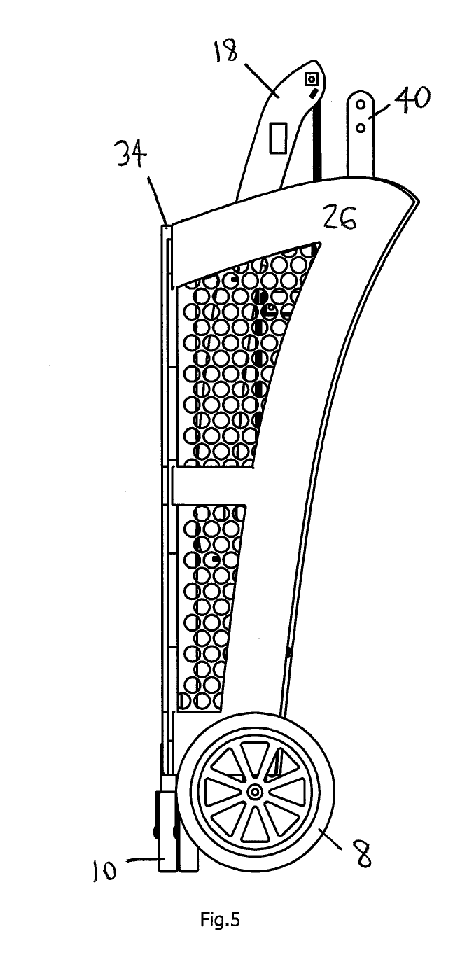

FIG. 6 is a front plan view of one embodiment of the invention in an open position;

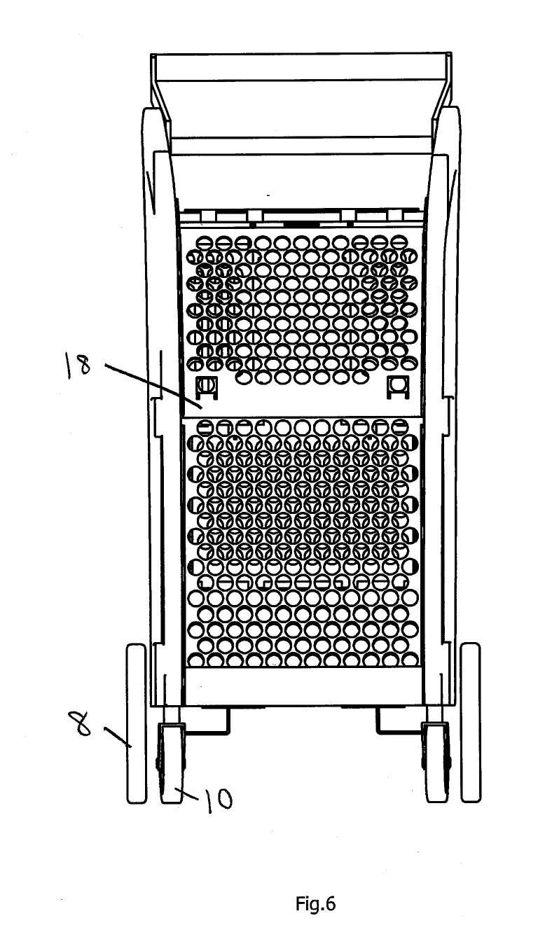

FIG. 7 is a front plan view of one embodiment of the invention in a closed position;

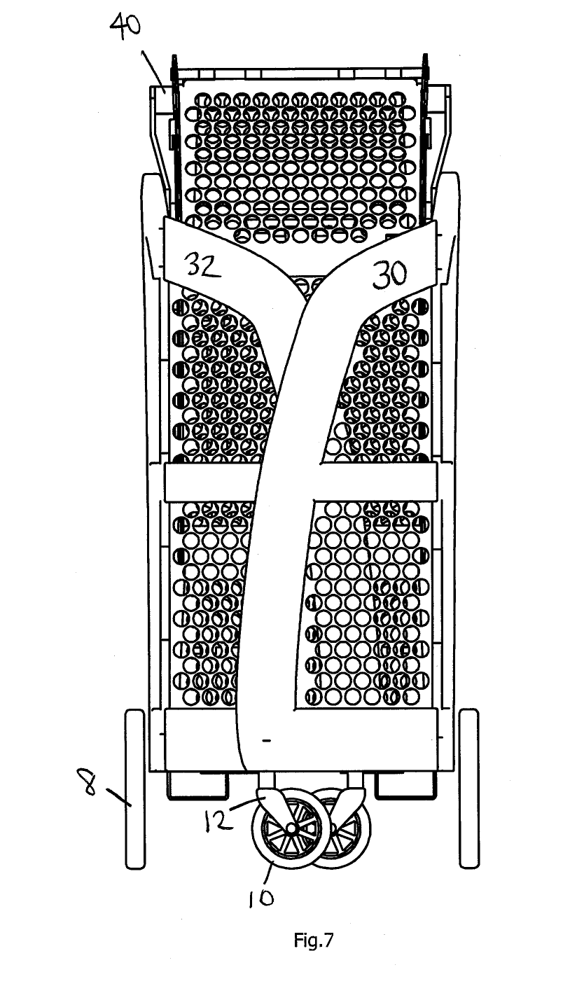

FIG. 8 is a top plan view of one embodiment of the invention in an open position; and

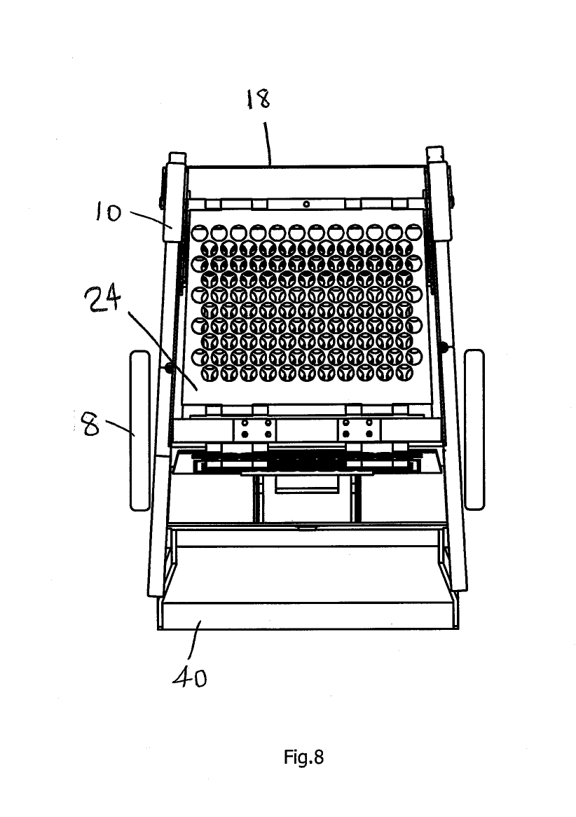

FIG. 9 is a top plan view of one embodiment of the invention in a closed position.

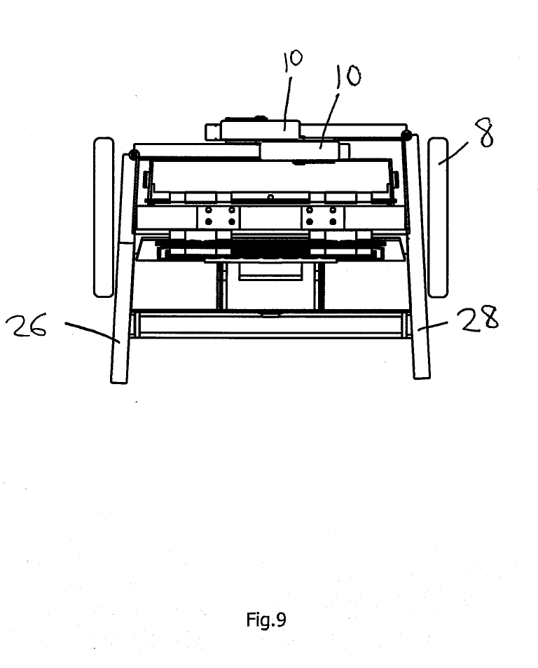

In the drawings, one embodiment of the invention is illustrated by way of example. It is to be expressly understood that the description and drawings are only for the purpose of illustration and as an aid to understanding, and are not intended as a definition of the limits of the invention.

### DESCRIPTION OF THE INVENTION

According to the present invention, there is provided a foldable cart 2. The cart includes at least two cargo storage compartments 4, 6 in vertical alignment, rolling means, steering means, and a handle.

Preferably, the rolling means include a pair of rear-mounted wheels 8, and a pair of front-mounted wheels 10. In one embodiment, one or more pairs of wheels may be axle-mounted. The steering means preferably comprise swivel connectors 12 for attaching each of the front wheels to the base of the cart.

In a preferred embodiment, the cart includes a lower cargo compartment having left and right side walls 14, 16, front and rear walls 18, 20, and a lower compartment floor, where the height of the front wall is less than the height of the left, right and rear walls. The cart preferably further includes an upper cargo compartment having left and right side walls 14, 16, front and rear walls 18, 20, the left, right, and an upper compartment floor 24, where the height of the front wall is less than the height of the left, right and rear walls, the upper floor forms a ceiling for the lower compartment, and the left walls, right walls, front walls and rear walls of the upper and lower compartments are each a unitary panel.

In a preferred embodiment, the upper and lower floors of the cart are hingedly attached to the rear wall. Each horizontal floor segment may be rotated upwardly about its rear edge into a position co-planar with the rear wall panel. Each of the left and right panels comprises a rearward fixed segment 26, 28, and a forward folding segment 30, 32. The forward folding segment of each panel is inwardly rotatable about the vertical line 34, 36 between the fixed and folding segments.

The structure of the cargo compartments preferably comprises a framework of sheet metal in which a plurality of openings 38 have been made to reduce the weight of the cart while permitting visual inspection of the contents of the compartments in the absence of an opaque cover.

In an alternate embodiment, the framework may consist of hollow metal tubing. The planar segments of the walls and floors may be formed of a mesh of metal strips. Preferably, the spacing of the metal strips permits viewing of the inside of each cargo compartment from outside of the compartment.

In an alternate embodiment of the present invention, a third cargo compartment may be formed by adding a third horizontal section and third front wall section between the lower and upper compartments. Additional cargo compartments are also possible. Each cargo compartment may be divided into sub-compartments by adding one or more dividers within the compartment.

The handle 40 of the cart preferably is rotatable between a lowermost position and one or more higher positions to permit use by users of differing heights.

In another embodiment of the invention, the walls and floors may be manufactured of Plexiglass™, plastic, fabric or other materials, and may be transparent or non-transparent.

The rear wheels of the cart preferably are 8 inch wheels. Alternatively, bicycle wheels may be used, or 4 inch wheels which may be folded inwardly to reduce the space required for storage of the folded cart. In one embodiment, an electric motor and a pair of drive wheels may be provided to permit motorized operation of the cart.

In an alternate embodiment, a radio frequency identification tag may be incorporated into the cart. This may enable communication between a cart and a user, permitting a motorized ‘smart’ version of a cart to follow its user or a user to locate a cart. In one embodiment, a hitch may be added to permit towing of the cart behind a bicycle or scooter. The cart may include security locking means attached to the cart for locking one or more compartments.

One or more covers may be provided to protect the cargo compartments from rain, and to secure the cargo against theft. Such a security cover may be manufactured of a heavy duty fabric and may include locking means. Covers may be designed for the cart as a whole, or may be designed to cover each compartment separately. Alternatively, one or more security liners may be included for placement within one or more compartments to provide added security to the compartment cargo. The security liners may be opaque fabric to prevent visual display of the compartment contents, or they may be fine mesh or solid liners which prevent extraction of the compartment contents.

In one embodiment, an upper compartment ceiling may be provided parallel to the floors and may be rotatable along its front and rear edges about the front and rear walls.

According to one embodiment, the cargo compartment of the cart may be 28 inches in height, 13 inches deep, and 17 inches wide. According to a second embodiment, the cargo compartment of the cart may be 28 inches in height, 19 inches deep, and 20 inches wide. The overall height of the cart will vary depending on the wheel kit used, and the height setting of the rotatable handle.

In one embodiment comprising a tubing framework, the cart may include a locking mechanism in at least one of the framework tubes of the left and right walls. In a locked position, a cable in the tubing engages with a spring-loaded pin extending from the front tubing of the floor panels. The user may disengage the cable by activating a release button in the framework near the handle. Once disengaged, the pin in the front tubing of the floor panel will disengaged, allowing the wall panel to be moved away from the floor panel, and the floor panel to be rotated upwardly towards the rear panel.

In operation, the folded cart may be assembled for use by unfolding sequentially the left and right side wall rotatable segments, and folding down the floor panels. Upon full rotation into a horizontal position, the distal ends of the floor panels will engage the openings in the framework of the right and left side panels. To refold the cart, the user must disengage the locking mechanism in the framing tubing, move the left and right wall panels outwardly, fold the floor panels upwardly into co-planar alignment with the rear panel, and fold the left and right walls fully inwardly.

It is to be understood that all matter described and depicted herein is illustrative and not limiting. Other variations of the preferred embodiment may also be practiced without departing from the scope of the invention.

1. A foldable cart comprising:
a. cargo storage means comprising a first lower cargo compartment and a second upper cargo compartment vertically aligned over the lower cargo compartment, the cargo storage means having a front wall, a rear wall, a left wall, a right wall, a lower compartment floor, and an upper compartment floor;
b. rolling means;
c. steering means; and
d. an adjustable height handle.

2. The foldable cart of claim 1, wherein the rolling means comprises at least one pair of rear-mounted wheels and one pair of front-mounted wheels.

3. The foldable cart of claim 2, wherein at least one of the pairs of wheels is mounted on an axle.

4. The foldable cart of claim 1, wherein the steering means comprises swivel connectors for attaching each of the front wheels to the lower compartment floor.

5. The foldable cart of claim 1, wherein the height of the front wall is less than the height of each of the left, right, and rear walls.

6. The foldable cart of claim 1, wherein the upper compartment floor forms a ceiling for the lower compartment.

7. The foldable cart of claim 1, further comprising an electric motor and a pair of drive wheels.

8. The foldable cart of claim 1, further comprising a radio frequency identification tag for tracking of the cart.

9. The foldable cart of claim 1, further comprising a locking mechanism for securely closing one or more of the compartments.

10. The foldable cart of claim 1, further comprising cover means adapted to fit the size and shape of the cart in its open position.

11. The foldable cart of claim 10, wherein the cover means comprises an opaque, waterproof, heavy duty fabric.

12. The foldable cart of claim 1, further comprising a security liner inserted along the inside surfaces of one or more of the compartments.

13. The foldable cart of claim 1, wherein each of the right and left walls comprise a first fixed vertical segment adjacent the rear wall, and a second rotatable vertical segment adjacent the front wall, the second vertical segments rotatable relative to the first vertical segments along their vertical length.

14. The foldable cart of claim 13, wherein each of the upper and lower floors is rotatable about its rearward edge where it connects with the rear wall and about its frontward edge where it connects with the front wall.

15. The foldable cart of claim 14, wherein the upper and lower floors may be rotated upwardly into a position parallel to the rear wall, and the second vertical segments of the left and right walls may be rotated inwardly to overlap in front of the front wall to fold the cart.

16. A foldable cart comprising:
a. cargo storage means including a first lower cargo compartment and a second upper cargo compartment vertically aligned over the lower cargo compartment, the cargo storage means having a front wall, a rear wall, a left wall, a right wall, a lower compartment floor, and an upper compartment floor wherein the height of the front wall is less than the height of each of the left, right, and rear walls, each of the right and left walls comprise a first fixed vertical segment adjacent the rear wall, and a second rotatable vertical segment adjacent the front wall, the second vertical segments rotatable relative to the first vertical segments along their vertical length, each of the upper and lower floors rotatable about its rearward edge where it connects with the rear wall and about its frontward edge where it connects with the front wall, and the upper compartment floor forming a ceiling for the lower compartment;
b. rolling means comprising at least one pair of rear-mounted wheels and one pair of front-mounted wheels, at least one of the pairs of wheels mounted on an axle;
c. steering means comprising swivel connectors for attaching each of the front wheels to the lower compartment floor;
d. an handle; and
e. a locking mechanism for securely closing one or more of the compartments.

17. The foldable cart of claim 16, further comprising an electric motor and a pair of drive wheels.

18. The foldable cart of claim 16, further comprising a radio frequency identification tag.

19. The foldable cart of claim 16, further comprising one or more dividers reversibly insertable into a compartment to form a plurality of sub-compartments.

20. The foldable cart of claim 16, wherein the upper and lower floors may be rotated upwardly into a position parallel to the rear wall, and the second vertical segments of the left and right walls may be rotated inwardly to overlap in front of the front wall to fold the cart.
